(19) United States
(12) Patent Application Publication
(10) Pub. No.: US 2025/0209842 A1
(43) Pub. Date: Jun. 26, 2025

(54) GEOLOGIC COMPUTER VISION REPORT PROCESSING FRAMEWORK

(71) Applicant: Schlumberger Technology Corporation, Sugar Land, TX (US)

(72) Inventors: Weijia Du, Cambridge (GB); Tom Jonsthovel, Lysaker (NO); Billy Baddeley, Abingdon (GB); Yezid Arevalo Romero, Katy, TX (US)

(21) Appl. No.: 18/985,136

(22) Filed: Dec. 18, 2024

Related U.S. Application Data
(60) Provisional application No. 63/613,167, filed on Dec. 21, 2023.

(51) Int. Cl. G06V 30/18; G06V 30/30

(52) U.S. Cl. CPC G06V 30/1801; G06V 30/30

(57) ABSTRACT

A method can include performing optical character recognition on a document to define spatial locations of bounding boxes for characters, where each bounding box includes at least one character; identifying a spatial location of keyword characters via a corresponding one of the bounding boxes; applying an edge detection technique to generate a skeletonized version of the document; determining borders within the skeletonized version of the document to define regions; and extracting the characters within one of the regions that includes the keyword characters.

### CROSS-REFERENCE TO RELATED APPLICATION(S)

The present disclosure claims priority from U.S. Provisional Appl. No. 63/613,167, filed on Dec. 21, 2023, entitled “GEOLOGIC COMPUTER VISION REPORT PROCESSING FRAMEWORK”, herein incorporated by reference in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In oil and gas exploration, geoscientists and engineers may acquire and analyze data to identify and locate various subsurface structures (e.g., horizons, faults, geobodies, etc.) in a geologic environment. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc.

In various instances, information, such as, for example, well log data, etc., may be present in the form of physical documents (e.g., pages of paper) and/or as images. For example, historical information from past field operations may be stored as scanned images and/or as paper that may be amenable to scanning. Extracting information from such documents (e.g., paper, image files, etc.) can be challenging and time consuming. To extract information with confidence as to, for example, groupings of characters, with accuracy as to the characters, can improve utilization of such information for one or more workflows. Additionally, accurate extraction of information can help to leverage time and resources expended to acquire such information.

### SUMMARY

A method can include performing optical character recognition on a document to define spatial locations of bounding boxes for characters, where each bounding box includes at least one character; identifying a spatial location of keyword characters via a corresponding one of the bounding boxes; applying an edge detection technique to generate a skeletonized version of the document; determining borders within the skeletonized version of the document to define regions; and extracting the characters within one of the regions that includes the keyword characters. A system can include one or more processors; memory accessible to at least one of the one or more processors; processor-executable instructions stored in the memory and executable to instruct the system to: perform optical character recognition on a document to define spatial locations of bounding boxes for characters, where each bounding box includes at least one character; identify a spatial location of keyword characters via a corresponding one of the bounding boxes; apply an edge detection technique to generate a skeletonized version of the document; determine borders within the skeletonized version of the document to define regions; and extract the characters within one of the regions that includes the keyword characters. One or more computer-readable storage media can include processor-executable instructions to instruct a computing system to: perform optical character recognition on a document to define spatial locations of bounding boxes for characters, where each bounding box includes at least one character; identify a spatial location of keyword characters via a corresponding one of the bounding boxes; apply an edge detection technique to generate a skeletonized version of the document; determine borders within the skeletonized version of the document to define regions; and extract the characters within one of the regions that includes the keyword characters. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various framework components associated with one or more geologic environments;

FIG. 2 illustrates examples of a basin, a convention and a system;

FIG. 3 illustrates an example of a system;

FIG. 4 illustrates an example of a method;

FIG. 5 illustrates an example of a graphic;

FIG. 6 illustrates an example of a graphic;

FIG. 7 illustrates an example of a graphic;

FIG. 8 illustrates an example of a graphic;

FIG. 9 illustrates an example of a graphic;

FIG. 10 illustrates an example of a graphic;

FIG. 11 illustrates an example of a data structure;

FIG. 12 illustrates an example of a graphic;

FIG. 13 illustrates an example of a graphic;

FIG. 14 illustrates an example of a method;

FIG. 15 illustrates an example of a method and an example of a system; and

FIG. 16 illustrates examples of computer and network equipment.

### DETAILED DESCRIPTION

This description is not to be taken in a limiting sense, but rather is made merely for the purpose of describing the general principles of the implementations. The scope of the described implementations should be ascertained with reference to the issued claims.

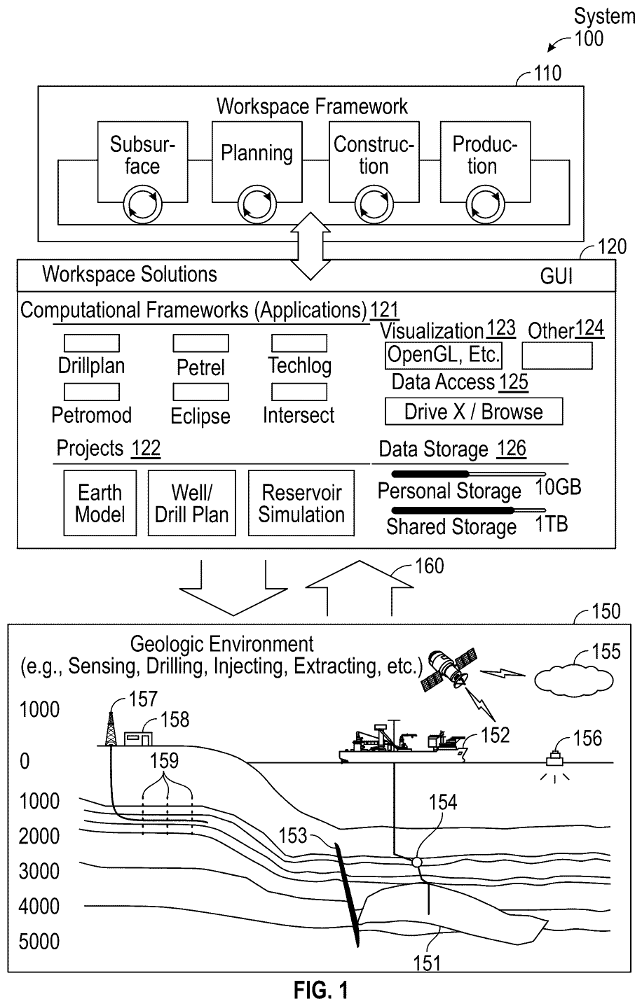

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas).

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (SLB, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where later acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data and/or log data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that includes layers of rock, geobodies, etc., that have corresponding positions that can be based on interpretation of seismic and/or other data (e.g., log data). A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

While several simulators are illustrated in the example of FIG. 1, one or more other simulators may be utilized, additionally or alternatively. For example, consider the VISAGE geomechanics simulator (SLB, Houston Texas), which includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc.

As mentioned, a framework may be implemented within or in a manner operatively coupled to the DELFI environment, which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

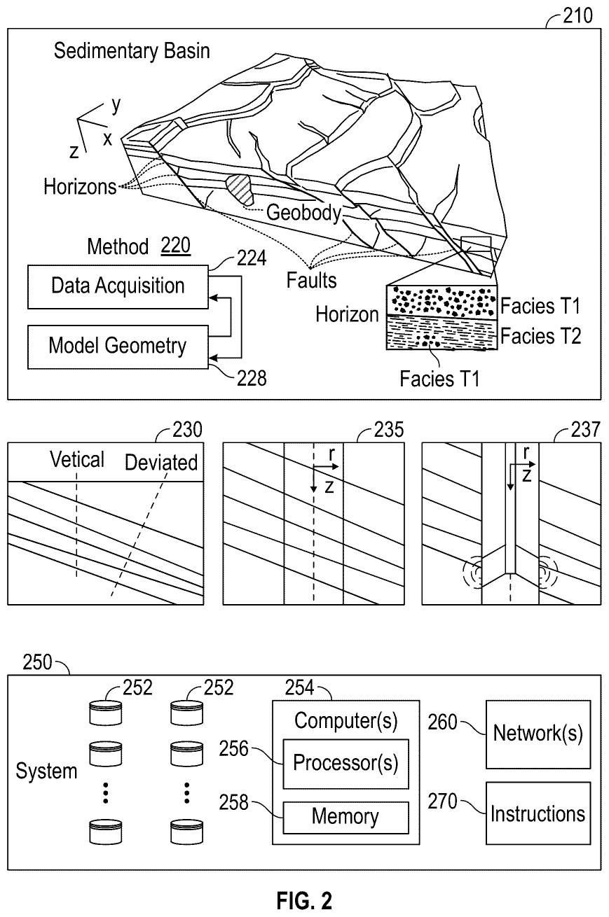

FIG. 2 shows an example of a sedimentary basin 210 (e.g., a geologic environment), an example of a method 220 for model building (e.g., for a simulator, etc.), an example of a formation 230, an example of a borehole 235 in a formation and an example of a system 250.

As an example, data acquisition, reservoir simulation, petroleum systems modeling, etc. may be applied to characterize various types of subsurface environments, including environments such as those of FIG. 1.

In FIG. 2, the sedimentary basin 210, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 220 includes a data acquisition block 224 and a model geometry block 228. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and log data. Furthermore, data may include depth and thickness maps stemming from facies variations (e.g., due to seismic unconformities) assumed to follow geological events (“iso” times) and data may include lateral facies variations (e.g., due to lateral variation in sedimentation characteristics).

As shown in FIG. 2, the formation 230 includes a horizontal surface and various subsurface layers. As an example, a borehole may be vertical. As another example, a borehole may be deviated. In the example of FIG. 2, the borehole 235 may be considered a vertical borehole, for example, where the z-axis extends downwardly normal to the horizontal surface of the formation 230. As an example, a tool 237 may be positioned in a borehole, for example, to acquire information. As mentioned, a borehole tool can include one or more sensors that can acquire borehole images via one or more imaging techniques. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, a borehole tool or downhole tool may be a logging tool, which may be a logging-while-drilling (LWD) tool, a measurement-while-drilling (MWD) tool, a wireline tool, a coiled tubing tool, etc. A tool can include one or more sensors that can acquire measurements, which may be recorded with respect to time, depth, depth and time, etc. Where measurements and/or information derived therefrom are presented along one axis with respect to another axis, such as, for example, time and/or depth, the presentation may be in the form of a log.

Logging may be considered a field operation that measures one or more properties with one or more electrically powered instruments. The record of the measurements may be in one or more forms, which may be digital, physical as on paper, etc. As to a paper log, consider a long strip of paper, which itself may also be called a log. Some examples of measurements include electrical properties (resistivity and conductivity at various frequencies), sonic properties, active and passive nuclear measurements, dimensional measurements of a bore, formation fluid sampling, formation pressure measurement, wireline-conveyed sidewall coring tools, and others. For wireline measurements, a tool (or sonde) may be lowered into an open bore on a multiple conductor, contra-helically armored wireline cable. As an example, once a tool string has reached the bottom of an interval of interest, measurements may be taken on the way out of the bore; noting that measurements may be taken alternatively or additionally on the way into a bore. As to taking measurements on the way out, such an approach may be performed in an attempt to maintain tension on a cable (e.g., which may stretch) as constant as possible for depth correlation purposes. As mentioned, measurements may be taken while a tool is being lowered into a bore, for example, consider doing so in an effort to lessen the amount of time the tool spends in the bore (e.g., consider certain hostile environments in which the tool electronics might be impacted by downhole temperatures). In various examples, a log may be referred to as an up log or as a down log, depending on overall movement direction of a tool in a bore.

In various instances, wireline measurements may be recorded continuously while a tool is moving; noting that certain fluid sampling and pressure-measuring tools may demand that a tool be stopped, which may increase the chance that the tool or cable might become stuck.

One or more LWD tools may be included on a drillstring, for example, near the bottom of a bottomhole assembly (BHA), where measurements may be recorded during drilling, during stationary periods where no drilling is occurring, during tripping in hole (e.g., running in hole (RIH)), during tripping out of hole (e.g., pulling out of hole (POOH)), etc.

One or more types of logs may be records of data acquired at surface. For example, consider mud logs (e.g., drilling fluid logs) that describe samples of drilled cuttings that are taken from mud and measured at surface.

Logs can include useful information and may be, depending on circumstances, resource intensive to acquire. For example, a LWD log depends on drilling, which can be a resource intensive field operation. In various instances, logs are maintained as confidential (e.g., confidential products) due to information contained therein, cost to acquire (e.g., labor, energy, equipment risk, borehole integrity risks, etc.), cost to process and/or analyze (e.g., labor, computing costs, use of proprietary applications, etc.), etc. In various instances, a log may include post-logging information, which may be generated by human and/or machine. In various instances, a log may include manually entered information such as, for example, annotations entered during logging by one or more individuals of a logging team. As explained, logs include information that can be beneficially utilized for one or more purposes, which can include decision making as to field operations, training of one or more machine learning models, etc.

As to training of one or more machine learning models, as explained, logs may be valuable and kept confidential such that they are not readily available for use as training data. As to another obstacle, logs may be in non-digital form or, for example, be in image form (e.g., bitmap, jpeg, tiff, etc.). For one or more reasons, log data may not be readily available for training of one or more machine learning models. Various types of machine learning models demand a substantial amount of training to generate accurate trained models, whether through supervised and/or unsupervised learning. If log data (e.g., data included in one or more logs) is not readily available and/or not readily available in a useful digital form, that may confound an ability to generate an accurate trained machine learning model.

As an example, logs may be utilized to detect and/or identify various types of subsurface features, which may include, for example, sedimentary bedding, faults and fractures, cuestas, igneous dikes and sills, metamorphic foliation, etc. In various instances, logs aim to see that which is unobservable to the human eye, noting that a borehole may be 100s of meters to 1000s of meters in length.

As shown in FIG. 2, the system 250 includes one or more information storage devices 252, one or more computers 254, one or more networks 260 and instructions 270. As to the one or more computers 254, each computer may include one or more processors (e.g., or processing cores) 256 and memory 258 for storing instructions, for example, consider the instructions 270 as including instructions executable by at least one of the one or more processors. As an example, a computer may include one or more network interfaces (e.g., wired or wireless), one or more graphics cards (e.g., one or more GPUs, etc.), a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, the system 250 may be local, remote or in part local and in part remote. As to remote resources, consider one or more cloud-based resources (e.g., as part of a cloud platform, etc.).

As an example, the instructions 270 may include instructions (e.g., stored in memory) executable by one or more processors to instruct the system 250 to perform various actions. As an example, the system 250 may be configured such that the instructions 270 provide for establishing one or more aspects of the workspace framework 110 of FIG. 1. As an example, one or more methods, techniques, etc. may be performed at least in part via instructions, which may be, for example, instructions of the instructions 270 of FIG. 2.

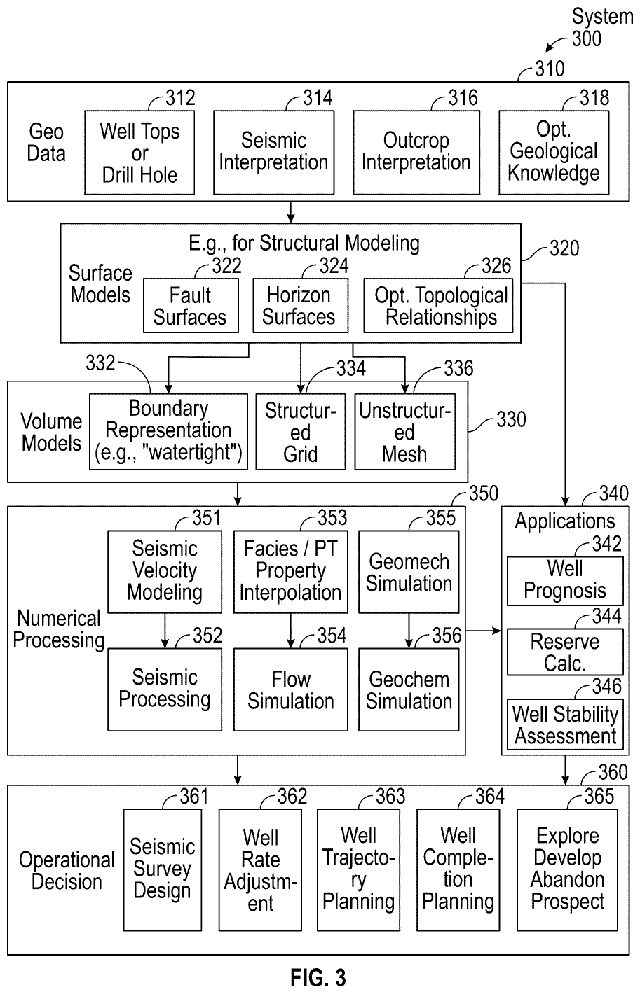

FIG. 3 shows an example of a system 300 that includes a geological/geophysical data block 310, a surface models block 320 (e.g., for one or more structural models), a volume modules block 330, an applications block 340, a numerical processing block 350 and an operational decision block 360. As shown in the example of FIG. 3, the geological/geophysical data block 310 can include data from well tops or drill holes 312, data from seismic interpretation 314, data from outcrop interpretation and optionally data from geological knowledge. As to the surface models block 320, it may provide for creation, editing, etc. of one or more surface models based on, for example, one or more of fault surfaces 322, horizon surfaces 324 and optionally topological relationships 326. As to the volume models block 330, it may provide for creation, editing, etc. of one or more volume models based on, for example, one or more of boundary representations 332 (e.g., to form a watertight model), structured grids 334 and unstructured meshes 336.

In the system 300, data of the data block 310 and/or one or more other blocks may be generated and/or received in the form of logs, which may include various types of data (e.g., sensor-based data, annotations, augmentations, synthetic data, simulation data, derived data, model-based data, etc.). Such data may provide for performance of one or more workflows, which may include automated workflows, semi-automated workflows, manual workflows, etc. As an example, one or more workflows may involve training of one or more machine learning models for one or more purposes.

As shown in the example of FIG. 3, the system 300 may allow for implementing one or more workflows, for example, where data of the data block 310 are used to create, edit, etc., one or more surface models of the surface models block 320, which may be used to create, edit, etc., one or more volume models of the volume models block 330. As indicated in the example of FIG. 3, the surface models block 320 may provide one or more structural models, which may be input to the applications block 340. For example, such a structural model may be provided to one or more applications, optionally without performing one or more processes of the volume models block 330 (e.g., for purposes of numerical processing by the numerical processing block 350). Accordingly, the system 300 may be suitable for one or more workflows for structural modeling (e.g., optionally without performing numerical processing per the numerical processing block 350).

As to the applications block 340, it may include applications such as a well prognosis application 342, a reserve calculation application 344 and a well stability assessment application 346. As to the numerical processing block 350, it may include a process for seismic velocity modeling 351 followed by seismic processing 352, a process for facies and petrophysical property interpolation 353 followed by flow simulation 354, and a process for geomechanical simulation 355 followed by geochemical simulation 356. As indicated, as an example, a workflow may proceed from the volume models block 330 to the numerical processing block 350 and then to the applications block 340 and/or to the operational decision block 360. As another example, a workflow may proceed from the surface models block 320 to the applications block 340 and then to the operational decisions block 360 (e.g., consider an application that operates using a structural model).

In the example of FIG. 3, the operational decisions block 360 may include a seismic survey design process 361, a well rate adjustment process 352, a well trajectory planning process 363, a well completion planning process 364 and a process for one or more prospects, for example, to decide whether to explore, develop, abandon, etc. a prospect.

Referring again to the data block 310, the well tops or drill hole data 312 may include spatial localization, and optionally surface dip, of an interface between two geological formations or of a subsurface discontinuity such as a geological fault; the seismic interpretation data 314 may include a set of points, lines or surface patches interpreted from seismic reflection data, and representing interfaces between media (e.g., geological formations in which seismic wave velocity differs) or subsurface discontinuities; the outcrop interpretation data 316 may include a set of lines or points, optionally associated with measured dip, representing boundaries between geological formations or geological faults, as interpreted on the earth surface; and the geological knowledge data 318 may include, for example knowledge of the paleo-tectonic and sedimentary evolution of a region.

As to a structural model, it may be, for example, a set of gridded or meshed surfaces representing one or more interfaces between geological formations (e.g., horizon surfaces) or mechanical discontinuities (fault surfaces) in the subsurface. As an example, a structural model may include some information about one or more topological relationships between surfaces (e.g. fault A truncates fault B, fault B intersects fault C, etc.).

As to the one or more boundary representations 332, they may include a numerical representation in which a subsurface model is partitioned into various closed units representing geological layers and fault blocks where an individual unit may be defined by its boundary and, optionally, by a set of internal boundaries such as fault surfaces.

As to the one or more structured grids 334, it may include a grid that partitions a volume of interest into different elementary volumes (cells), for example, that may be indexed according to a pre-defined, repeating pattern. As to the one or more unstructured meshes 336, it may include a mesh that partitions a volume of interest into different elementary volumes, for example, that may not be readily indexed following a pre-defined, repeating pattern (e.g., consider a Cartesian cube with indexes I, J, and K, along x, y, and z axes).

As to the seismic velocity modeling 351, it may include calculation of velocity of propagation of seismic waves (e.g., where seismic velocity depends on type of seismic wave and on direction of propagation of the wave). As to the seismic processing 352, it may include a set of processes allowing identification of localization of seismic reflectors in space, physical characteristics of the rocks in between these reflectors, etc.

As to the facies and petrophysical property interpolation 353, it may include an assessment of type of rocks and of their petrophysical properties (e.g. porosity, permeability), for example, optionally in areas not sampled by well logs or coring. As an example, such an interpolation may be constrained by interpretations from log and core data, and by prior geological knowledge.

As to the flow simulation 354, as an example, it may include simulation of flow of hydro-carbons in the subsurface, for example, through geological times (e.g., in the context of petroleum systems modeling, when trying to predict the presence and quality of oil in an un-drilled formation) or during the exploitation of a hydrocarbon reservoir (e.g., when some fluids are pumped from or into the reservoir).

As to geomechanical simulation 355, it may include simulation of the deformation of rocks under boundary conditions. Such a simulation may be used, for example, to assess compaction of a reservoir (e.g., associated with its depletion, when hydrocarbons are pumped from the porous and deformable rock that composes the reservoir). As an example a geomechanical simulation may be used for a variety of purposes such as, for example, prediction of fracturing, reconstruction of the paleo-geometries of the reservoir as they were prior to tectonic deformations, etc.

As to geochemical simulation 356, such a simulation may simulate evolution of hydrocarbon formation and composition through geological history (e.g., to assess the likelihood of oil accumulation in a particular subterranean formation while exploring new prospects).

As to the various applications of the applications block 340, the well prognosis application 342 may include predicting type and characteristics of geological formations that may be encountered by a drill-bit, and location where such rocks may be encountered (e.g., before a well is drilled); the reserve calculations application 344 may include assessing total amount of hydrocarbons or ore material present in a subsurface environment (e.g., and estimates of which proportion can be recovered, given a set of economic and technical constraints); and the well stability assessment application 346 may include estimating risk that a well, already drilled or to-be-drilled, will collapse or be damaged due to underground stress.

As to the operational decision block 360, the seismic survey design process 361 may include deciding where to place seismic sources and receivers to optimize the coverage and quality of the collected seismic information while minimizing cost of acquisition; the well rate adjustment process 362 may include controlling injection and production well schedules and rates (e.g., to maximize recovery and production); the well trajectory planning process 363 may include designing a well trajectory to maximize potential recovery and production while minimizing drilling risks and costs; the well trajectory planning process 364 may include selecting proper well tubing, casing and completion (e.g., to meet expected production or injection targets in specified reservoir formations); and the prospect process 365 may include decision making, in an exploration context, to continue exploring, start producing or abandon prospects (e.g., based on an integrated assessment of technical and financial risks against expected benefits).

As an example, a framework can provide for extracting information from one or more types of documents, which may be in one or more formats. For example, consider one or more of the following file formats: JPEG, GIF, PNG, TIFF, BMP, and portable document format (PDF). Of the foregoing, the PDF may be utilized as a format for image file and/or physical document conversions (e.g., converting into a PDF file). Various utilities exist for handling PDF files, which may provide for compression to smaller file sizes with some amount of loss in quality. As an example, the application ADOBE ACROBAT may be utilized (e.g., resident or online) as an application that provides various utilities.

As to image files, consider vector image files as a type of image file. These file types may be utilized for resizing images, as they are endlessly scalable. Image proportions may be computed and automatically adjusted using line art equations, making it simple to modify images without affecting file size or image clarity. As another example, consider raster image files. Rather than using algorithms, raster image files are based on pixels where the number of pixels and number of pixels per inch (PPI) or dots per inch (DPI) determines the image resolution. Raster images can be more difficult to scale without affecting the image quality. As to image resolution, images that have more PPI or DPI have a higher resolution, although this will not always guarantee that an image will appear crisp and clean; and, images with fewer pixels or that are stretched may appear blurry. If you need to enlarge a low-resolution image, you may need to use a program that can adjust the resolution while retaining the pixel quality.

As an example, a method may implement one or more computer vision techniques. For example, consider implementation of one or more computer vison driven techniques to extract information on a relatively complex layout scanned document in a non-searchable format such as, for example, a non-searchable Portable Document Format (PDF) (e.g., standardized as ISO 32000). In such an example, the PDF document can include raster graphics. For example, consider raster graphics represented as a two-dimensional picture in a rectangular matrix or grid of square pixels. A raster graphic may be characterized by width and height of an image in pixels and by number of bits per pixel. A raster graphic may be referred to as a raster image or a bitmap graphic or a bitmap image. As mentioned, such an image within a document may include text within the image where such text is not present in a searchable form. For example, to make the text searchable, an optical character recognition (OCR) technique may be applied that can recognize characters in an image and covert those characters to text, which may be stored to memory.

As an example, a method may employ one or more types of techniques available from one or more open-source libraries, which may not demand data labelling for training. For example, consider a method where a user can enter a keyword for a table present in an image such as a title of the table. In response, the method may output content of the table in a structured format. For example, consider a JSON format, a DataFrame format, etc.

As to JSON, JavaScript Object Notation, it is an open standard file format and data interchange format that uses human-readable text to store and/or transmit data objects that can include attribute-value pairs and arrays or other serializable values. As to DataFrame, consider the PANDAS software library written for the Python programming language for data manipulation and analysis, which offers data structures and operations for manipulating numerical tables and time series. The name PANDAS is derived from the term panel data. PANDAS library features may be utilized for data analysis and associated manipulation of tabular data in one or more DataFrames. PANDAS provides for importing data from various file formats such as comma-separated values (csv), JSON, PARQUET, SQL database tables or queries, and EXCEL. PANDAS provides for various data manipulation operations such as merging, reshaping, selecting, as well as data cleaning, and data wrangling features.

As mentioned, a method may provide for extraction of information from a table in an image. In such an example, the structure of the table may be irregular, for example, a table may include one or more irregularities that deviate from a rectangular table formed by columns and rows. A table may be characterized by its shape, location of entries, location of headers or column identifiers, location of row identifiers, etc., where one or more of such features may make a table irregular.

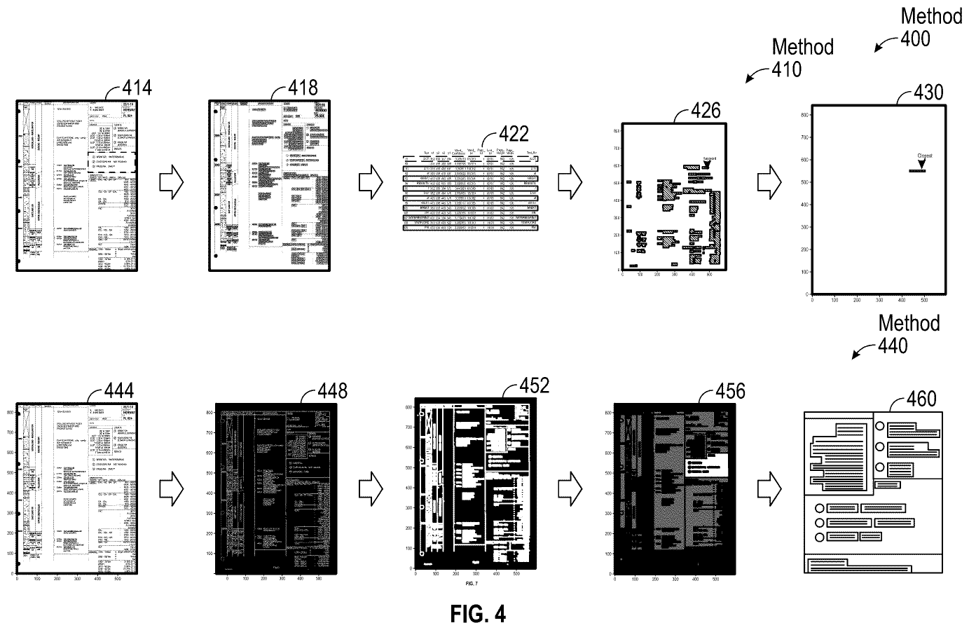

FIG. 4 shows an example of a method 400 as represented by various graphics. The method 400 may include a method 410 and a method 440, which may, for example, be referred to as stages that may be performed at least in part in a serial and/or a parallel manner. As an example, the method 410 may be referred to as a first stage or stage 1 and the method 440 may be referred to as a second stage or stage 2. As an example, the method 410 may aim to identify a nearest occurrence of text to a given target text (e.g., keyword). As an example, the method 440 may aim to collect all associated text within a region, which may be identified as a box, a table, etc. The method 440 may be implemented particularly where various text lines may be spaced apart from one another such that they do not readily form a connected region upon performance of the method 410. For example, the method 440 may be implemented to help assure that all text in a region (e.g., a box, a table, etc.) is properly extracted (e.g., associated with a target text or keyword).

As an example, a region may be analogous to an island where a document may include multiple islands, for example, delineated by lines that may be akin to rivers or other water features. As an example, the method 400 may be implemented to identify an island using, for example, a keyword bounding box or a closest bounding box to a keyword, or both (e.g., to have a higher certainty).

Below, various aspects of the methods 410 and 440 are described, which can involve implementation of one or more types of computer vision techniques, some of which may be available in one or more computer vision technique libraries. As an example, one or more computer vision techniques may utilize constructs such as coordinates, bounding boxes, optical character recognition (OCR), etc.

In the example of FIG. 4, the method 410 includes receiving an image 414 that can be subjected to OCR for identification of characters within the image (e.g., text, etc.) where the method 410 can include generating bounding boxes 418 as areas associated with the characters; noting that one or more parameters may control bounding box sizes, for example, via a maximum space and/or a minimum space between characters, etc. As shown, the method 410 can include generating a data structure 422 that can provide for associations between characters and bounding boxes (e.g., spatial areas within the received image). Given the generated data structure, the method 410 can include identifying a location of a target character or character string (e.g., text or keyword) 426 and identifying a spatially closest occurrence of a character or character string to the target 430, which may, for example, operate according to one or more criteria such as, for example, a directional criterion or directional criteria. In the example of FIG. 4, the method 410 can include searching spatially downwardly such that an identified spatially closest occurrence is at a level below the target.

In the example of FIG. 4, the method 440 can include implementing one or more computer vision techniques that may aim to identify one or more regions in an image, which, as explained, may be referred to as one or more islands. For example, consider an approach that may act to skeletonize an image through use of character redaction, edge detection, edge enhancement, and edges as borders analysis. In such an approach, borders that may delineate regions such as, for example, tables, etc., may be identified and utilized to define one or more regions. As an example, a region may be a polygonal region that may be defined by one or more lines that may be detectable as one or more edges. As an example, one or more techniques may be employed to determine regions such as, for example, shooting rays from a point and determining when each ray hits an edge (e.g., a border or boundary).

As shown in the example of FIG. 4, the method 440 can include receiving an image 444 that includes pixel representations of characters (e.g., text) and, for example, other features (e.g., borders, etc.). In such an example, the method 440 may receive the image 444 as a binary image (e.g., black and white using 0s and 1s) or it may include converting the image 444 to a binary image. Next, the method 440 can include forming a skeletonized version 448 of the image 444, which may involve applying one or more edge detection techniques and extracting edges. As an example, the method 440 may include generating a further skeletonized version 452 by applying one or more edge enhancement techniques to the skeletonized version 448. For example, consider applying an edge dilation technique that can increase sizes of various edges. As an example, through edge enhancement, a method may be able to more readily identify one or more regions within the image 444 where such one or more regions may, for example, correspond to a table. For example, consider an identified region version 456 of the image 444 where a particular region is shown as being highlighted where that particular region may be defined by edges (e.g., enhanced edges).

As an example, the method 440 may provide for utilizing edges to define a region. In such an approach, a table encompassed by the region (e.g., within the region) may be distinguished from one or more other regions. For example, consider a target term “results” that may be utilized to extract a table labeled “results” from an image where that table may be adjacent to one or more other tables such as, for example, a table labeled “casings” and a table labeled “targets”. As explained, a table may be defined by various lines (e.g., borders) where the lines do not necessarily form a rectangle. For example, the table labeled “results” is formed by six lines (e.g., borders) such that it is a six-sided polygon rather than a rectangle. As to defining a region, a method may employ a connected component type of approach where, for example, a computer vision technique may be applied to identify a connected component within an image (e.g., using edges, enhanced edges, etc.). In such an example, the technique may be more robustly applied where edges are not broken such that one region will not appear to have a connection with another region via a broken line or other gap. As an example, an edge enhancement technique may be applied to help assure that edges are not broken to thereby increase robustness of region identification. As an example, a broken edge may be just that, i.e., broken, where an edge enhancement technique such as edge dilation aims to fix the broken edge. For example, the method 440 may include applying edge dilation to fix one or more broken edges and thereby appropriately keep adjacent tables separated from a component point of view (e.g., for use of one or more component type of computer vision techniques).

In the example of FIG. 4, the method 440 may encounter one or more issues as to edge detection of characters (e.g., text) where such character edges, upon dilation, extend to an edge of a region (e.g., a border, etc.). As an example, the method 440 may be made more robust to such issues by utilizing bounding box information generated via the method 410. For example, consider an approach where the method 440 access the data structure 422 for bounding box information for characters where the bounding box information can be applied to redact (e.g., erase, block out, etc.) characters within the bounding boxes. In such an approach, the method 440 may rid the image 444 of character edges and thereby prevent bleeding over a character edge to a border (e.g., as an edge) upon application of an edge dilation technique.

In the example of FIG. 4, the method 440 can include identifying a region 460 as associated with a target such that characters within the region may be extracted to form, for example, a collection of characters associated with the target. As explained, a target may be a table where characters (e.g., text) within the table may be associated with a region using coordinate information of bounding boxes (see, e.g., coordinate information of a data structure). As an example, the method 440 may access the data structure 422 for one or more purposes, which may include character redaction and/or region identification using one or more bounding boxes as associated with one or more characters.

As explained, a method may implement an approach that may provide for identifying text within bounding box coordinates within an image, which may be present on a page (e.g., a document page, etc.). Such a method may then include building a matrix, which may be a page-sized matrix. Such a matrix can be a data structure that associates characters (e.g., text) and bounding boxes (e.g., 2D coordinates of bounding boxes). As an example, through use of the matrix (e.g., a data structure), a method may provide for identifying a closest connected region to a keyword, which, as mentioned may be a title of a table.

As explained, in the example of FIG. 4, various actions may be referred to as first stage actions or, collectively, a first stage. In such an example, following a first stage, a method can include a process for extracting characters (e.g., text) of an identified region. For example, in FIG. 4, the method 400 may include performing a binary transformation on a document to generate a binary image followed by cropping out or redacting bounding box areas to generate a relatively content-free skeletonized version of the binary image. Next, the method 400 may include implementing one or more edge detection techniques to identify one or more borders (e.g., boundaries), which may be or include one or more table borders, that may define regions akin to islands. As an example, bounding box-based redaction (e.g., erasure) may be applied prior to or after application of an edge detection technique. As shown in the example of FIG. 4, the method 400 can include identifying characters within a region associated with a keyword (e.g., a target character string such as a table title) where the characters may be extracted as text, for example, corresponding with a table.

As explained, various actions in the example of FIG. 4 may be referred to as a second stage, which can include converting a scanned PDF document to a binary image file; removing all text or text within an identified region of interest (ROI) in the image by using bonding box information (e.g., as generated during a first stage); extracting edges of the binary image file, for example, by using a Canny function (e.g., OpenCV) and/or one or more edge detection techniques; dilating the extracted edges, for example, to connect and/or fix one or more broken edges to make a connected component; identifying connected components by using the connected components function (e.g., OpenCV) and/or one or more other suitable techniques; selecting the component where the connected region (e.g., identified in the first stage) is located; and selecting all the bonding boxes covered by this connected component. For example, the graphic representing the action 460 in FIG. 4 includes approximately eleven bounding boxes that include text as may be associated with the keyword “results”. As explained, where removal of characters is performed, it may occur prior to or after application of an edge detection technique. In either instance, such an approach may help to make region identification more robust by reducing risks of character edges being dilated to an extent that they bleed over into border edges and/or edges of one or more other features that may facilitate region identification.

In the example of FIG. 4, the method 400 may include a first stage that aims to identify the nearest text to a target word (e.g., a keyword) and a second stage that aims to collect all text in the same box (e.g., table). As explained, a table may be irregular. For example, the table in the graphic representing the action 460 in FIG. 4 is irregular and not fully structured as a unit defined by regular columns and rows. In the example of FIG. 4, the second stage may be applied because, for example, if text lines are far from one another, they may not form a connected region upon execution of the first stage. Hence, the second stage can help to assure that all text in a box (e.g., table) is extracted.

As explained, a framework may provide for implementation of one or more methods, which may involve utilizing one or more stages. For example, consider a two-stage approach as applied to a non-searchable PDF image file. In such an example, a first stage may utilize one or more of TESSERACT, DoctTR, etc., libraries to identify text using one or more OCR techniques, which may provide for getting all text identified within bounding box coordinates on a page. The first stage may then build a PDF page size empty matrix, followed by identification of the closest connected region to a keyword (e.g., table title, etc.) by using one or more functions such as, for example, the OpenCV regionprops functions, etc. After completion of the first stage, the framework may commence a second stage that converts the PDF document to a binary image, followed by removal of all the text or text in an ROI in the binary image by using bonding box information. As explained, a second stage may utilize one or more edge detection (e.g., extraction) techniques such as, for example, a Canny technique, to extract edges of a PDF image. As a quality control measure, the second stage may include applying one or more techniques to extracted edges, for example, to dilate edges to connect and/or fix one or more broken edges to make a connected component if a connected component is not fully formed via edge extraction alone. The second stage may include identifying connected components by implementing one or more techniques (e.g., OpenCV connected components function, etc.). The second stage may then select the component where the connected region (e.g., as identified in the first stage) is located, followed by selecting all the bonding boxes covered by the connected component.

As explained, a first stage can aim to identify the nearest text to a target word while a second stage aims to collect all text in a common box and/or table. As explained, the second stage can address scenarios where text lines are relatively far from one another such that they may not form a connected region upon processing by the first stage. The second stage can help to assure that all text in a box and/or table is suitably extracted.

As mentioned, a library such as the OpenCV library may be implemented, which is an open-source computer vision library of various programming functions that may be implemented for real-time computer vision.

As to edge detection, as mentioned, a Canny technique may be implemented. As an example, a Canny technique may apply a Gaussian filter to smooth an image in order to reduce noise, find intensity gradients of the image, apply gradient magnitude thresholding or lower bound cut-off suppression to diminish spurious response to edge detection, apply double threshold to determine potential edges, and track edges by hysteresis. Such an approach may finalize detection of edges by suppressing other edges that are weak and not connected to strong edges.

As an example, a method may proceed without a binary pixel transform and/or a binary pixel transform may be performed as part of an edge detection process. As an example, a binary pixel transform may be performed at one or more stages within a workflow, which may depend on one or more of type of document, type of OCR, type of edge detection, etc.

As to the regionprops function, it may be available through OpenCV and/or MATHWORKS. For example, the regionprops function can be implemented to measure properties such as area, centroid, and bounding box, for each object (connected component) in an image. The function regionprops supports both contiguous regions and discontiguous regions. As an example, regionprops may be implemented to find one or more unique objects in one or more binary images using 8-connected neighborhoods for 2-D images and maximal connectivity for higher dimension images.

As to connected components in OpenCV, it is an iterative technique that provides for labeling an image using eight or four connectivity pixels. For example, two pixels may be deemed connected if they have the same value and are neighbors.

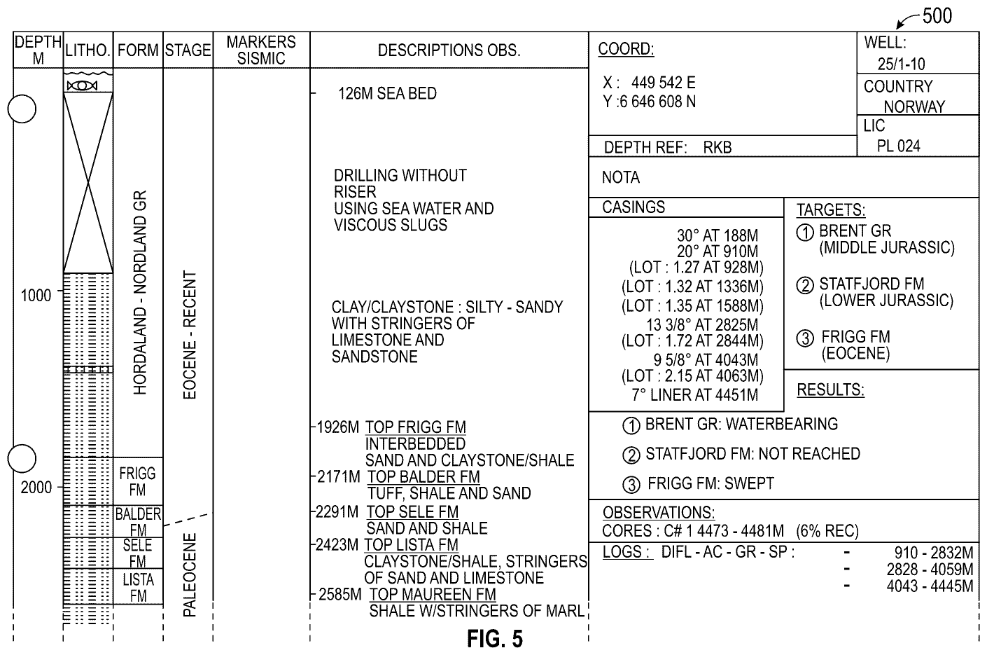

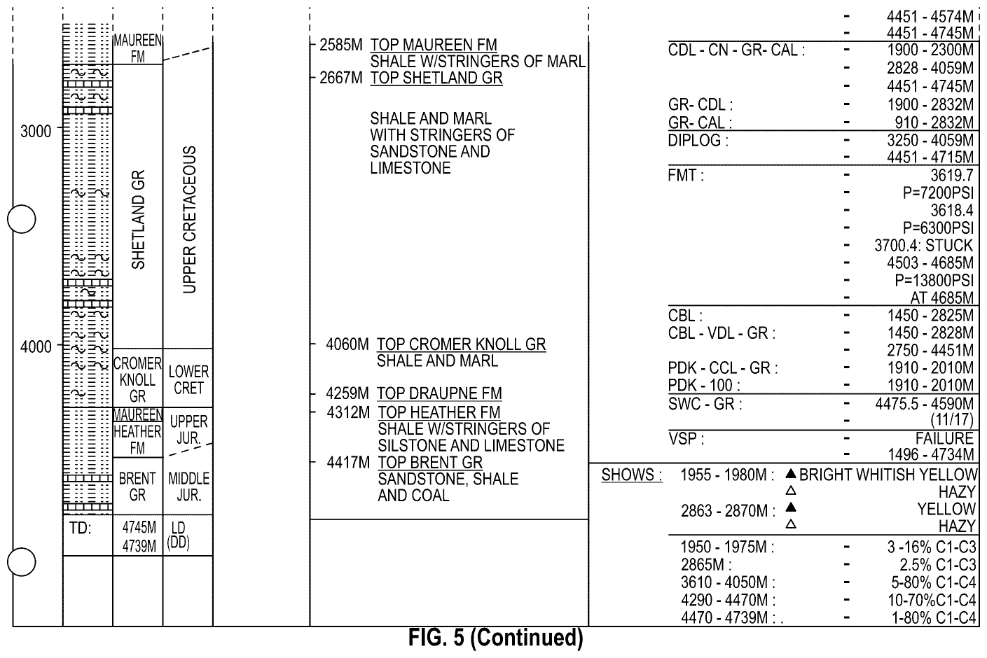

FIG. 5 shows an example graphic 500. As shown, the graphic includes various regions that may be irregularly shaped. For example, consider a rectangular region near the upper right-hand side that includes the terms casings, targets and results (e.g., character strings). In such an example, a user may be interested in extracting the results, which are within an irregular polygonal region. For example, the term results is off-centered and characters within the results table are relatively centered though spanning columns associated with a table for casings and a table for targets. As such, a strict column-based approach is unlikely to accurately extract entries in the results table.

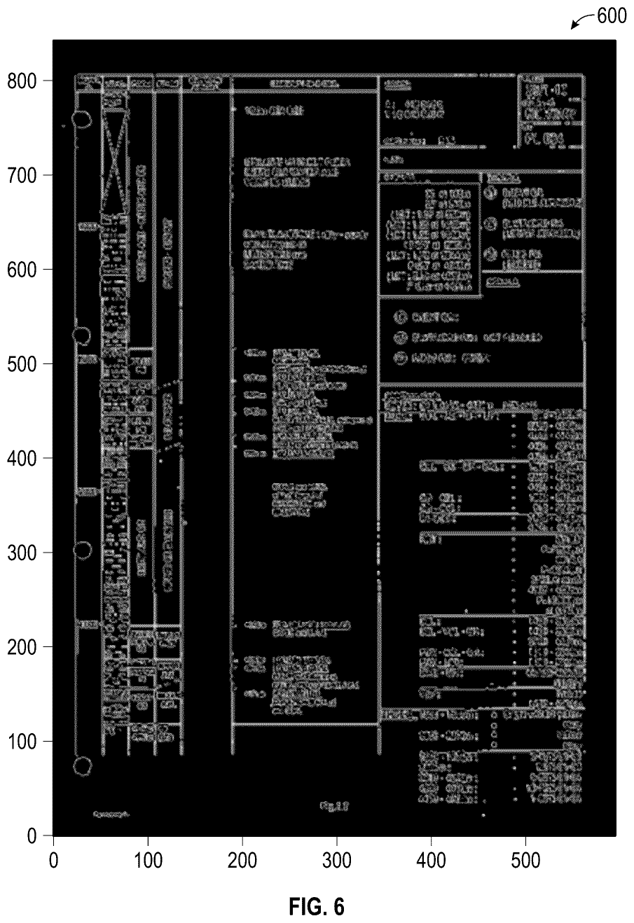

FIG. 6 shows an example graphic 600. As shown, the graphic 600 of FIG. 6 is effectively a skeleton of the graphic 500 of FIG. 5. For example, a PDF document may be transformed into a binary image, for example, using white for features and black for background. Such a binary image may be suitable for subsequent processing, which may include further skeletonization, for example, to facilitate identification of indicia as to one or more borders (e.g., boundaries), which may include, for example, one or more table borders (e.g., table boundaries). In the example of FIG. 6, the graphic 600 is generated as output after application of an edge detection technique where the characters within the graphic 500 have not been erased (e.g., redacted, etc.), for example, via use of bounding box information. As shown in the example of FIG. 6, in various areas, a character edge may be relatively close to a border edge or other region defining feature. As explained, character redaction may help to reduce risks of character edge bleed over into a border edge or other region defining feature.

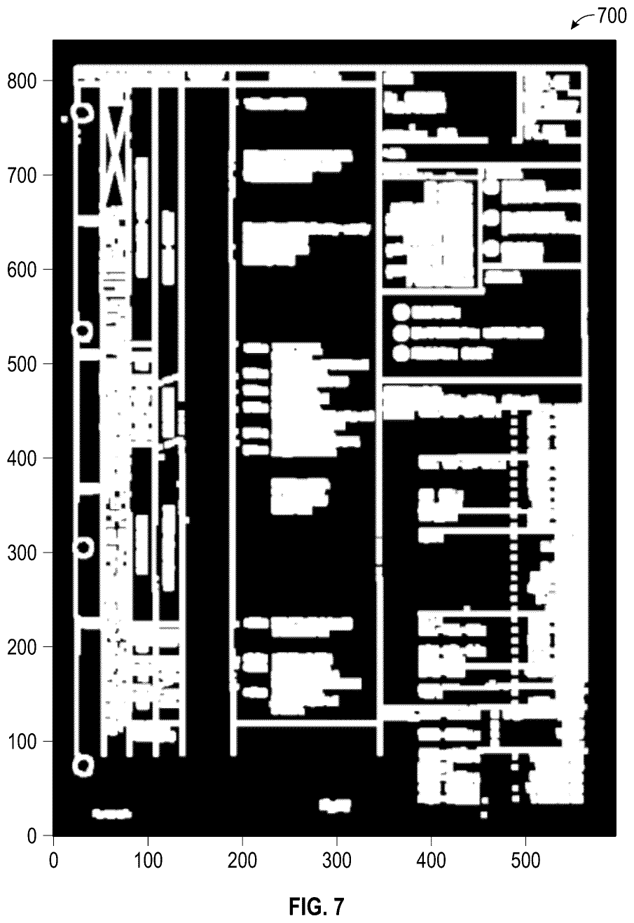

FIG. 7 shows an example graphic 700. As shown, the graphic 700 of FIG. 7 is effectively a further skeletonized version of the graphic of FIG. 6 (e.g., each with successively less information as to particular characters and more grossly representing structures). As explained, a method may include a cropping out or redaction type of process may be implemented that effectively deletes pixels associated with characters (e.g., text) such that indicia of borders that demarcate regions can be more readily identified. In such an approach, certain content is erased from the binary image. For example, pixel values can be changed within a bounding box to be the same value, which differs from a background value. In such an approach, edge detection may be applied, for example, as a second stage process to identify borders of regions (e.g., tables, etc.). In the example graphic 700, it is generated as output from application of an edge enhancement technique to the graphic 600 of FIG. 6. In particular, the edge enhancement technique involves edge dilation that can help to make border edges more distinct and/or connected. As explained, an edge enhancement technique may help to fix broken edges such that a connected component computer vision technique may be applied in a more robust manner for purposes of region identification.

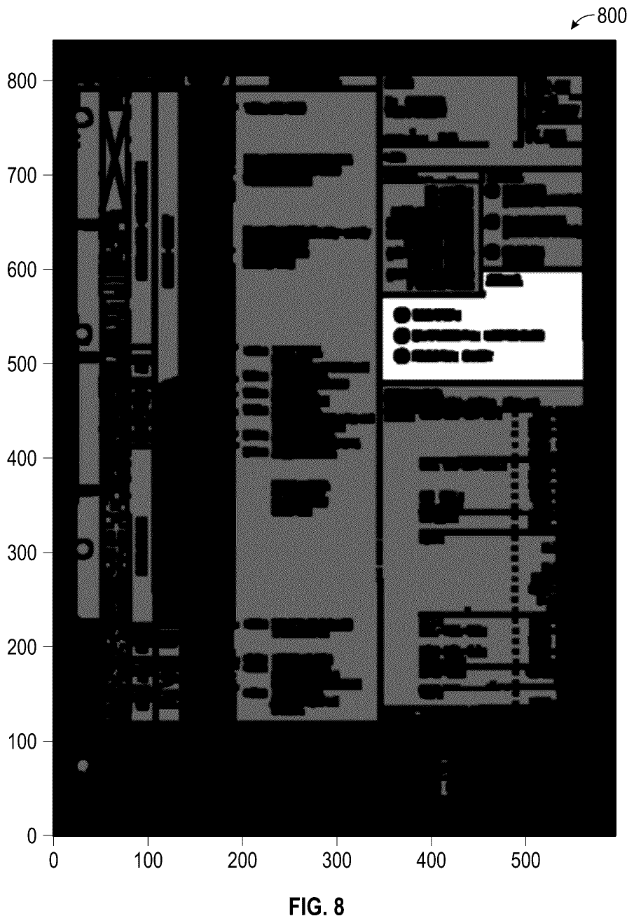

FIG. 8 shows an example graphic 800. As shown in the graphic 800 of FIG. 8, a region is identified as including the keyword results, which corresponds to a table of results. In the example graphic 800, the region may be considered an island where various bounding boxes and hence corresponding characters exist within the island. As explained, a border of a region may be other than strictly rectangular. For example, the region identified in the graphic 800 of FIG. 8 is substantially polygonal with approximately six borders (e.g., more than four borders). In the example of FIG. 8, the graphic 800 may include multiple connected components, which, for example, may be amenable to processing using one or more other keywords. For example, consider use of “casings” as a keyword and/or “targets” as a keyword. Thus, in various instances, processing of an image may provide for extracting of characters (e.g., alphanumeric, etc.) from one or more regions that may correspond to one or more tables.

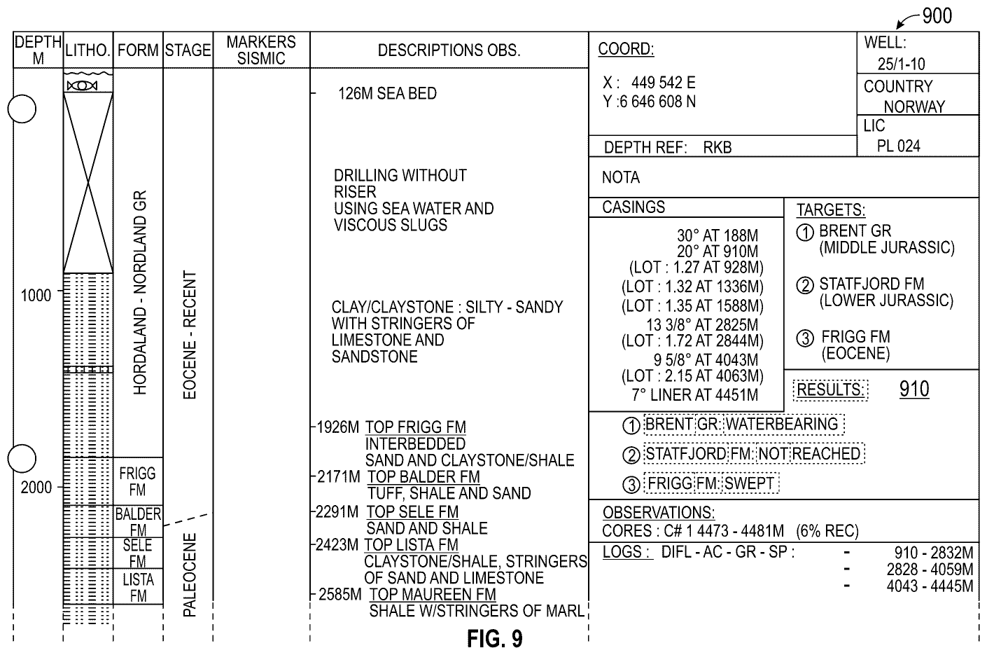

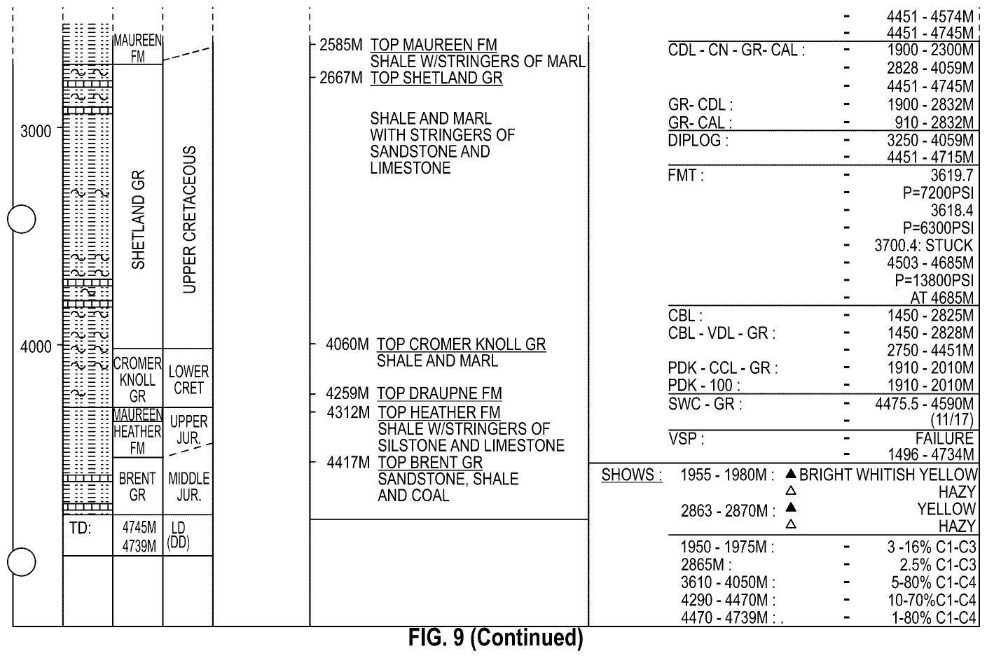

FIG. 9 shows an example graphic 900. As shown in the graphic 900 of FIG. 9, a region 910 identified as including the keyword results is now collectively associated with additional characters (e.g., text) within the region. As such, the text within the table entitled results has been identified, which may be stored for utilization in one or more workflows, etc.

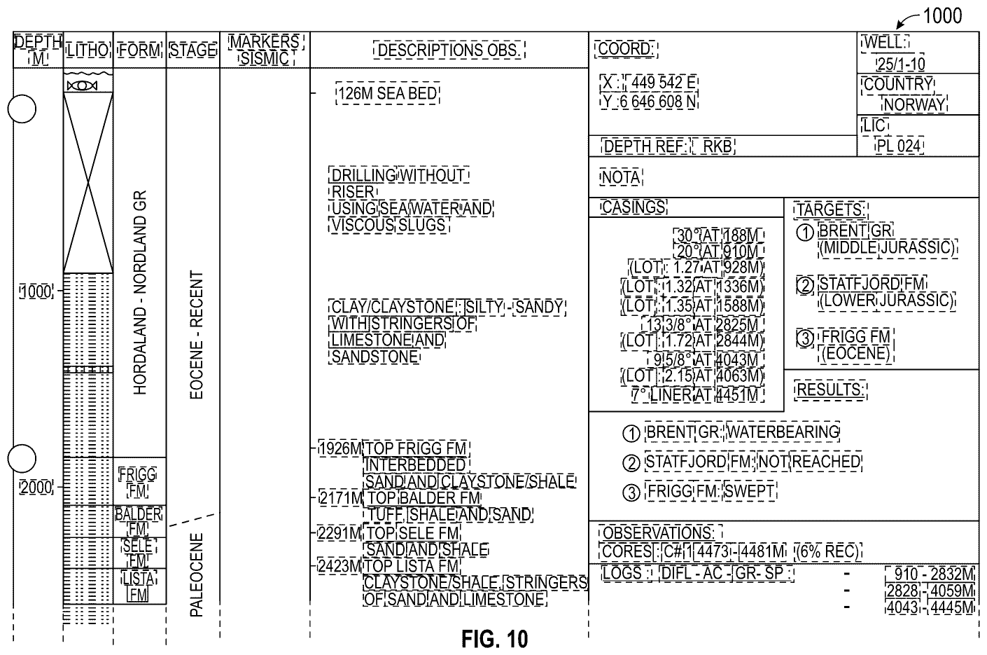

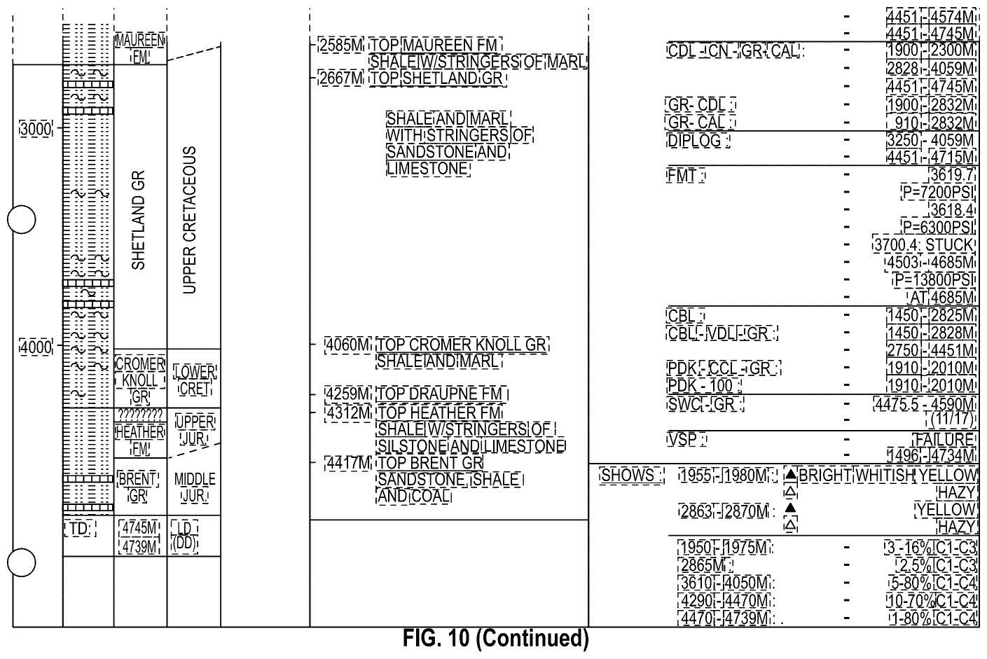

FIG. 10 shows an example graphic 1000, which includes bounding boxes for various instances of text within a document. As shown, the text can be identified using one or more techniques that may provide for a bounding box for each word, acronym, etc. For example, as to “BRENT GR:”, two bounding boxes are present, one for “BRENT” and another for “GR:”. Such an approach may utilize a corpus that can include specialized terms such as, for example, terms associated with particular types of logs.

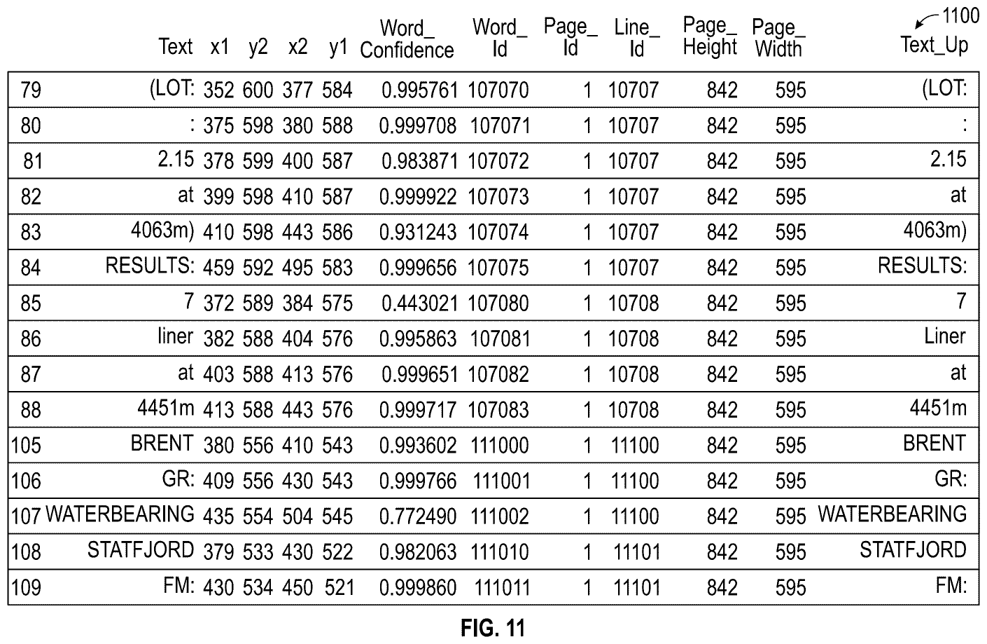

FIG. 11 shows an example of a data structure 1100 that includes a listing of text along with entries for bounding box coordinates (e.g., x1, y2, x2, y1), word_confidence, word_id, page_id, line_id, page_height, page_width, and text_up. In such an example, each portion of text as identified can be associated with a special position or region within a document (e.g., a page).

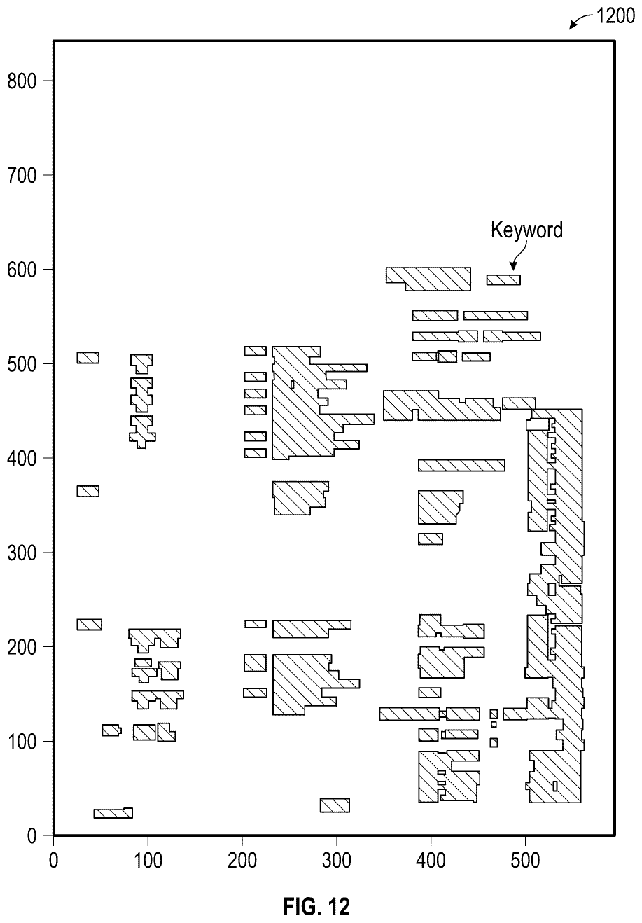

FIG. 12 shows an example of a graphic 1200 where the bounding boxes, which may be specified by the data structure 1100 of FIG. 11, are represented as being blank (e.g., empty). In the example of FIG. 12, an arrow identifies the bounding box associated with a keyword (e.g., results).

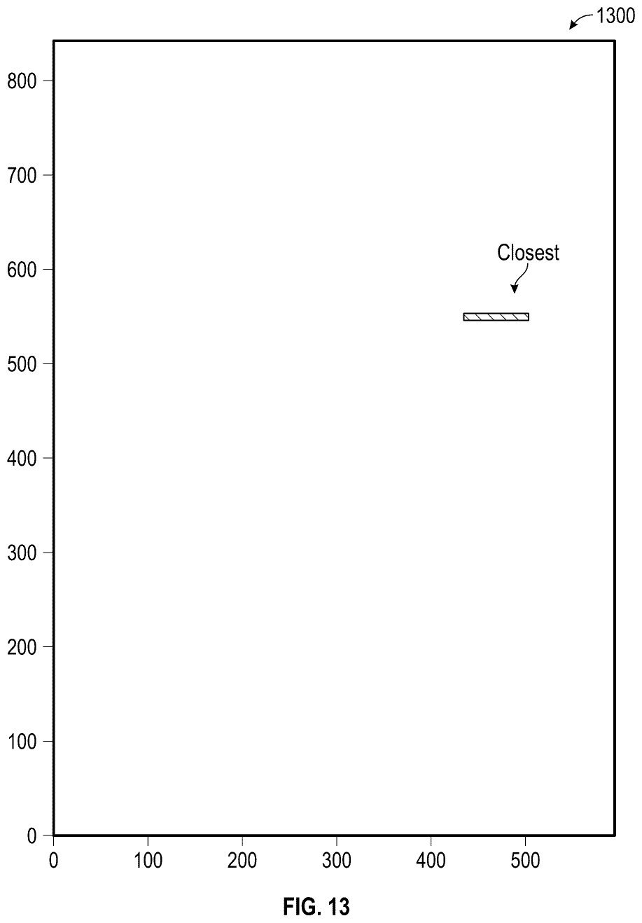

FIG. 13 shows an example of a graphic 1300 where a bounding box closest to the identified keyword is represented, which, from reference to the graphic 900 of FIG. 9, is shown to correspond to the text “WATERBEARING”. As explained, a framework may provide for receipt of a keyword, which may be received automatically from a data structure, received responsive to input via a graphical user interface rendered to a display, etc. As an example, a workflow may be implemented using a framework where one or more documents are selected and where one or more keywords are provided.

As explained, a framework may provide for extracting text from a document where the text is present in a region that may be identified through application of various techniques. As an example, a framework may implement various techniques for one or more types of regions. For example, where a paragraph of text is present as a standard paragraph form, such text may be extracted without resorting to details of a first stage and a second stage as explained with respect to the example pertaining to the table entitled results.

As an example, a region may be defined by borders where text appears within the region, which may be one or more characters. As an example, a border of a region may be formed by a continuous line or continuous lines. As to dashed lines, as an example, a border may be formed at least in part by one or more dashed lines where spaces between the dashes may be relatively small (e.g., pixelwise comparatively to dashes). As an example, a border of a region may be defined as a closed border such that the region is an enclosed region. As an example, a border may be a polygonal border that encloses a region (e.g., a closed polygon). As an example, a region may be enclosed by a polygonal border in a manner that is convex or not convex.

As an example, a bounding box may be defined using 2D coordinates that may specify x and y values (e.g., x1, y2, x2, y1) where such a bounding box may surround text (e.g., one or more characters). As an example, an OCR technique may utilize one or more parameters. For example, consider a parameter that operates as a threshold as to space between characters (e.g., terms, etc.). As an example, a bounding box may surround one word or multiple words. As explained, a bounding box may include one or more types of punctuation such as, for example, a colon, a semi-colon, etc. As explained, inside a bounding box (e.g., an area), one or more characters may be present where an association therebetween may be stored in a data structure. In such an approach, the location or space occupied by the one or more characters is known and accessible. As an example, a data structure may be a data frame (e.g., DataFrame, etc.). As an example, in a data structure, each row may associate text and a bounding box. As an example, an OCR technique may provide for various options as to data structure(s) for output.

As an example, a PDF document page may be considered a matrix where, within the matrix, are one or more bounding boxes. For example, coordinates of the one or more bounding boxes may be indexes of the matrix where the matrix represents the PDF document page.

As explained, the regionprops function may be implemented to identify the closest region to a keyword. For example, given a matrix and a keyword, the location of the keyword may be identified for purposes of spatial associations. As explained, the regionprops function utilizes the concept of connectivity and may handle contiguous regions and/or discontiguous regions. As explained, a bounding box area may be white while an area between two bounding boxes may be black. In such an example, a binary image type of approach may be implemented. As an example, connectivity may be determined using one or more distances where, for example, a connection may depend on a closest distance. For example, consider the table entitled results where in a downward direction a bounding box for the term waterbearing has a closest distance to the bounding box for the title results. In some instances, for example, two bounding boxes may overlap without a space between them. For example, consider the bounding boxes for the terms “BRENT” and “GR:”.

As an example, a bounding box proximity approach may be a preliminary approach in an overall approach for extracting text of a table responsive to receipt of a keyword (e.g., as dependent on coordinates of a bounding box of the keyword in a matrix).

As explained, in a second stage, a PDF document may be converted into a binary image (e.g., black and white). In such an example, the bounding box areas may be cropped out of the binary image, for example, by referring to their coordinates in a data structure. By cropping out the bounding boxes and hence their one or more corresponding characters, borders (or boundaries) may be remaining. As explained, such borders (or boundaries) may represent a skeletonized version of the PDF document. In such a skeletonized version, the task of identifying region boundaries (e.g., table boundaries, etc.) can be facilitated (e.g., made more efficient). As to cropping, it may be effectively a redaction type of process where the area of each bounding box is effectively transformed to a particular value such as, for example, white in a black and white image where other white pixels may be present as representing borders (e.g., boundaries) of one or more tables, etc. (see, e.g., the graphic 700 of FIG. 7).

As an example, a document may include regions that may be analogized akin to islands separated by water. As explained, a keyword may be received and an island identified as a region where characters within the region may be associated with the keyword and extracted therewith to provide output as to the content of that region, which may be a table. As an example, a second stage may aim to identify a region that may be defined as being inside a region and outside of bounding boxes within that region. For example, an island may include bodies with water within where those bodies are associated with bounding boxes, which, in turn, are associated with characters.

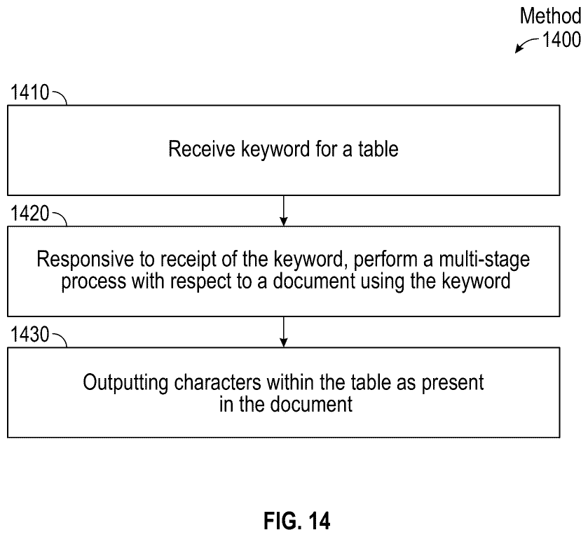

FIG. 14 shows an example of a method 1400 that includes a reception block 1410 for receiving a keyword for a table; a performance block 1420 for, responsive to receipt of the keyword, performing a multi-stage process with respect to a document using the keyword; and an output block 1430 for outputting characters within the table as present in the document.

As explained, a multi-stage process may include one stage that associates a keyword (e.g., keyword characters) with one or more bounding boxes (e.g., a closest connected component to a keyword) and another stage that identifies regions as may be defined by borders to thereby associate one or more connected components to one of the identified regions, which may be, for example, a table (e.g., a region defined by borders). In such an example, a data structure generated in one stage may be utilized in another stage. For example, consider a data structure with bounding boxes that include characters as generated in a first stage being utilized to crop out areas in a second stage to facilitate detection of borders that can define regions (e.g., via edge detection, etc.). In such an approach, the appropriate region may be identified using a keyword where that region includes the closest connected component to the keyword. As explained, one stage may generate a data structure and one or more closely connected components to a keyword while another stage may generate regions where a particular region can be identified using a location of the keyword where the one or more closely connected components may be associated with the keyword (e.g., as entries in a table that has the keyword as a label or title).

In various examples, content of a region may be identified once the appropriate region itself is identified using a keyword. In various examples, one stage may suffice. For example, consider a scenario where bounding boxes closest to a keyword bounding box overlap, which may form a single block. In such an example, as the characters are within a single block, that unified block may be considered, for example, as including all the content of a table. However, where bounding boxes do not overlap, uncertainty may exist as to the content of a table, which may be clarified through implementation of another stage that aims to define regions (e.g., via borders, etc.).

As an example, in a multi-stage process, one stage may generate bounding boxes for characters within a document and another stage may generate regions within the document. In such an example, for a given keyword, one region may be identified and where bounding boxes within that region can provide for extraction of associated characters.

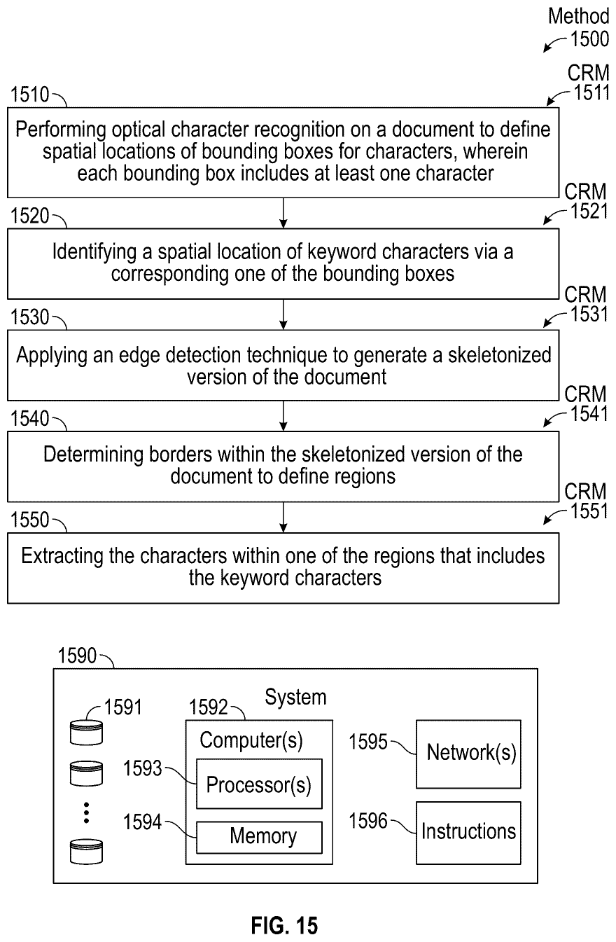

FIG. 15 shows an example of a method 1500 that includes a performance block 1510 for performing optical character recognition on a document to define spatial locations of bounding boxes for characters, where each bounding box includes at least one character; an identification block 1520 for identifying a spatial location of keyword characters via a corresponding one of the bounding boxes; an application block 1530 for applying an edge detection technique to generate a skeletonized version of the document; a determination block 1540 for determining borders within the skeletonized version of the document to define regions; and an extraction block 1550 for extracting the characters within one of the regions that includes the keyword characters.

In such an example, the method may include a transformation block for transforming the document into a binary pixel image, for example, with a first pixel value, as a background value, and a second pixel value. In such an example, the application block 1530 may apply an edge detection technique to generate a skeletonized version of the binary pixel image; noting that an edge detection technique itself may provide for a transformation of a document into a binary pixel image. As an example, a transformation block may be utilized at one or more times during a method. For example, consider transforming prior to applying edge detection, which may provide for improved edge detection. As an example, edge detection may be applied before transformation to a binary pixel image. As an example, edge detection and/or OCR may be applied to one or more types of documents that are in one or more types of formats (e.g., binary, grayscale, color, etc.). As an example, output of an edge detection technique may be a binary output such as, for example, a binary mask. As an example, edge detection may be applied to generate a pixel image that may be a binary, grayscale, color, etc., pixel image. As an example, a method may include performing an edge detection technique that detects edges and that generates a binary pixel image (e.g., that includes detected edges, etc.).

The method 1500 is shown in FIG. 15 in association with various computer-readable media (CRM) blocks 1511, 1521, 1531, 1541 and 1551. Such blocks generally include instructions suitable for execution by one or more processors (or processor cores) to instruct a computing device or system to perform one or more actions. While various blocks are shown, a single medium may be configured with instructions to allow for, at least in part, performance of various actions of the method 1500. As an example, a computer-readable medium (CRM) may be a computer-readable storage medium that is non-transitory and that is not a carrier wave. As an example, one or more of the blocks 1511 to 1551 may be in the form of processor-executable instructions, for example, consider the one or more sets of instructions 270 of the system 250 of FIG. 2, etc.

In the example of FIG. 15, the system 1590 includes one or more information storage devices 1591, one or more computers 1592, one or more networks 1595 and instructions 1596. As to the one or more computers 1592, each computer may include one or more processors (e.g., or processing cores) 1593 and memory 1594 for storing the instructions 1596, for example, executable by at least one of the one or more processors 1593 (see, e.g., the blocks 1511 to 1561). As an example, a computer may include one or more network interfaces (e.g., wired or wireless), one or more graphics cards, a display interface (e.g., wired or wireless), etc.

As an example, a method may include rendering one or more graphics to a display, for example, as part of a graphical user interface (GUI). As an example, a method may include controlling hardware to render graphics to a display where, for example, the graphics may include one or more graphical controls that may be actuated via use of one or more human input devices (HIDs). In such an example, a human may interact with hardware to control a method, which may include, for example, quality control, selection of an edge detection technique, etc., which may provide for extraction of particular characters from a document or documents. As an example, extracted characters from a region of a document may be processed for sake of quality, comparison to other characters, etc. For example, consider comparing numeric characters to one or more expected numeric characters, which may provide for detecting a change in one or more properties as characteristics of a geologic region. In such an example, consider expected numeric characters as representing property values acquired at one time while extracted numeric characters may represent property values acquired at another time. In such an example, if the characters differ upon comparison, that may indicate a change in one or more property values of a geologic region between the two times. As an example, documents may represent different times where a method may automatically extract characters and determine time associated differences (e.g., for two or more times, etc.). In such an example, one or more differences may be related to one or more human and/or one or more natural processes with respect to a geologic region (e.g., production of fluid via a well, fracturing due to natural seismic activity, etc.).

As an example, a computer program product can include computer-executable instructions to instruct a computing system to perform one or more methods such as, for example, the method 1500 of FIG. 15, etc.

As an example, a method can include performing optical character recognition on a document to define spatial locations of bounding boxes for characters, where each bounding box includes at least one character; identifying a spatial location of keyword characters via a corresponding one of the bounding boxes; applying an edge detection technique to generate a skeletonized version of the document; determining borders within the skeletonized version of the document to define regions; and extracting the characters within one of the regions that includes the keyword characters. In such an example, the method may include setting areas within the bounding boxes to a pixel value to reduce risk of character edge bleed over to one or more region edges. As an example, characters within one of the regions may include characters of a table. As an example, keyword characters may include characters of a table heading. As an example, regions may include at least two table regions.

As an example, a method may include generating a data structure for spatial locations of bounding boxes for characters, for example, where the data structure may include confidence indicators as to confidence of optical character recognition for one or more strings of characters.

As an example, a method may include determining borders by implementing an edge enhancement technique. In such an example, the method may include implementing a connected component function to identify a connected region as one of a number of regions. In such an example, the method may include identifying bounding boxes within a connected region as the one of the number of regions. In such an example, extracting characters within the one of the number of regions that includes keyword characters may include accessing characters within the identified bounding boxes.

As an example, a method may include storing extracted characters within one of a number of regions to a data storage device.

As an example, a document may be a single page document. As an example, a document may include multiple pages.

As an example, a document may include geologic information. For example, consider geologic information that includes at least one log (e.g., a well log, etc.). In such an example, the at least one log may be oriented vertically (e.g., as presented in a document).

As an example, one of a number of regions may include a polygonal border that includes four side or, for example, more than four sides.

As an example, a system can include one or more processors; memory accessible to at least one of the one or more processors; processor-executable instructions stored in the memory and executable to instruct the system to: perform optical character recognition on a document to define spatial locations of bounding boxes for characters, where each bounding box includes at least one character; identify a spatial location of keyword characters via a corresponding one of the bounding boxes; apply an edge detection technique to generate a skeletonized version of the document; determine borders within the skeletonized version of the document to define regions; and extract the characters within one of the regions that includes the keyword characters.

As an example, one or more computer-readable storage media can include processor-executable instructions to instruct a computing system to: perform optical character recognition on a document to define spatial locations of bounding boxes for characters, where each bounding box includes at least one character; identify a spatial location of keyword characters via a corresponding one of the bounding boxes; apply an edge detection technique to generate a skeletonized version of the document; determine borders within the skeletonized version of the document to define regions; and extract the characters within one of the regions that includes the keyword characters.

As an example, a computer program product can include one or more computer-readable storage media that can include processor-executable instructions to instruct a computing system to perform one or more methods and/or one or more portions of a method.

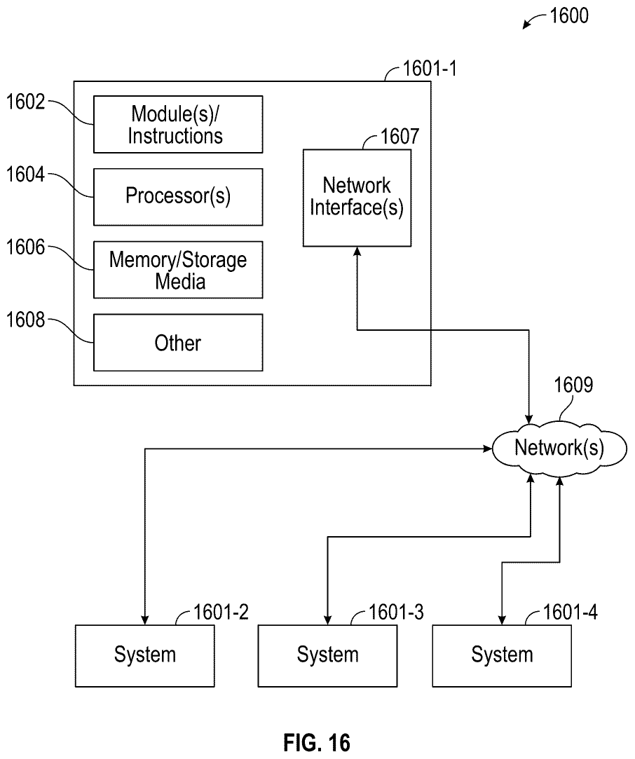

In some embodiments, a method or methods may be executed by a computing system. FIG. 16 shows an example of a system 1600 that can include one or more computing systems 1601-1, 1601-2, 1601-3 and 1601-4, which may be operatively coupled via one or more networks 1609, which may include wired and/or wireless networks. As shown, one or more other components 1608 may be included in a computing system.

As an example, a system can include an individual computer system or an arrangement of distributed computer systems. In the example of FIG. 16, the computer system 1601-1 can include one or more modules 1602, which may be or include processor-executable instructions, for example, executable to perform various tasks (e.g., receiving information, requesting information, processing information, simulation, outputting information, etc.).

As an example, a module may be executed independently, or in coordination with, one or more processors 1604, which is (or are) operatively coupled to one or more storage media 1606 (e.g., via wire, wirelessly, etc.). As an example, one or more of the one or more processors 1604 can be operatively coupled to at least one of the one or more network interface 1607. In such an example, the computer system 1601-1 can transmit and/or receive information, for example, via the one or more networks 1609 (e.g., consider one or more of the Internet, a private network, a cellular network, a satellite network, etc.).

As an example, the computer system 1601-1 may receive from and/or transmit information to one or more other devices, which may be or include, for example, one or more of the computer systems 1601-2, etc. A device may be located in a physical location that differs from that of the computer system 1601-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1606 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
performing optical character recognition on a document to define spatial locations of bounding boxes for characters, wherein each bounding box includes at least one character;
identifying a spatial location of keyword characters via a corresponding one of the bounding boxes;
applying an edge detection technique to generate a skeletonized version of the document;
determining borders within the skeletonized version of the document to define regions; and
extracting the characters within one of the regions that includes the keyword characters.

2. The method of claim 1, comprising setting areas within the bounding boxes to a pixel value to reduce risk of character edge bleed over to one or more region edges.

3. The method of claim 1, wherein the characters within the one of the regions comprise characters of a table.

4. The method of claim 1, wherein the keyword characters comprise characters of a table heading.

5. The method of claim 1, wherein the regions comprise at least two table regions.

6. The method of claim 1, comprising generating a data structure for the spatial locations of the bounding boxes for the characters.

7. The method of claim 6, wherein the data structure comprises confidence indicators as to confidence of the optical character recognition for one or more strings of characters.

8. The method of claim 1, wherein determining borders comprises implementing an edge enhancement technique.

9. The method of claim 8, comprising implementing a connected component function to identify a connected region as the one of the regions.

10. The method of claim 9, comprising identifying the bounding boxes within the connected region as the one of the regions.

11. The method of claim 10, wherein the extracting the characters within the one of the regions that includes the keyword characters comprises accessing characters within the identified bounding boxes.

12. The method of claim 1, comprising storing the extracted characters within the one of the regions to a data storage device.

13. The method of claim 1, wherein the document is a single page document.

14. The method of claim 1, wherein the document comprises multiple pages.

15. The method of claim 1, wherein the document comprises geologic information.

16. The method of claim 15, wherein the geologic information comprises at least one log.

17. The method of claim 16, wherein the at least one log is oriented vertically.

18. The method of claim 1, wherein the one of the regions comprises a polygonal border that comprises more than four sides.

19. A system comprising:
one or more processors;
memory accessible to at least one of the one or more processors;
processor-executable instructions stored in the memory and executable to instruct the system to:
perform optical character recognition on a document to define spatial locations of bounding boxes for characters, wherein each bounding box includes at least one character;
identify a spatial location of keyword characters via a corresponding one of the bounding boxes;
apply an edge detection technique to generate a skeletonized version of the document;
determine borders within the skeletonized version of the document to define regions; and
extract the characters within one of the regions that includes the keyword characters.

20. One or more computer-readable storage media comprising processor-executable instructions to instruct a computing system to:
perform optical character recognition on a document to define spatial locations of bounding boxes for characters, wherein each bounding box includes at least one character;
identify a spatial location of keyword characters via a corresponding one of the bounding boxes;
apply an edge detection technique to generate a skeletonized version of the document;
determine borders within the skeletonized version of the document to define regions; and
extract the characters within one of the regions that includes the keyword characters.
